(19) United States
(12) Patent Application Publication
(10) Pub. No.: US 2011/0150301 A1
(43) Pub. Date: Jun. 23, 2011

(54) Face Identification Method and System Using Thereof

(75) Inventors: Kai-Tai Song, Hsinchu City (TW); Meng-Ju Han, Sanxia Township (TW); Shih-Chieh Wang, Taipei City (TW)

(73) Assignee: INDUSTRIAL TECHNOLOGY RESEARCH INSTITUTE, Hsinchu (TW)

(21) Appl. No.: 12/830,519

(22) Filed: Jul. 6, 2010

(30) Foreign Application Priority Data
Dec. 17, 2009 (TW) 98143391

(51) Int. Cl. G06K 9/62; G06K 9/00

(52) U.S. Cl. 382/118; 382/159

(57) ABSTRACT

A face identification method includes the following steps. First, first and second sets of hidden layer parameters, which respectively correspond to first and second database character vectors, are obtained by way of training according to multiple first and second training character data. Next, first and second back propagation neural networks (BPNNs) are established according to the first and second sets of hidden layer parameters, respectively. Then, to-be-identified data are provided to the first BPNN to find a first output character vector. Next, whether the first output character vector satisfies an identification criterion is determined. If not, the to-be-identified data are provided to the second BPNN to find a second output character vector. Then, whether the second output character vector satisfies the identification criterion is determined. If yes, the to-be-identified data are identified as corresponding to the second database character vector.

This application claims the benefit of Taiwan application Serial No. 098143391, filed Dec. 17, 2009, the subject matter of which is incorporated herein by reference.

### BACKGROUND

1. Technical Field

The disclosure relates in general to a face identification method, and more particularly to a face identification method for specific members, wherein the method simultaneously applies multiple back propagation neural networks (BPNNs) to perform comparison and identification operations on multiple database character vectors of the to-be-identified data and the database.

2. Description of the Related Art

In the modern age, in which the technology changes with each passing day, the intelligent robot technology is developed in a flourishing manner, and is widely applied to facilitate the human's life. Generally speaking, if the robot can interact with the human and decide its behavior independently, the precondition needed is the reliable and real-time image identification interface so that the robot can capture the important message from the outside, and thus respond accordingly. Consequently, in the application of the home robot, for example, it is possible to respond the users with different identifications with different independent behaviors so that the robot is no longer a freezing machine and may even become a family companion. Thus, it is an important direction in the industry to design a face identification method, which can perform the face identification operation in a real-time manner.

U.S. Pat. No. 7,142,697 (hereinafter referred to as '697 patent), issued on Nov. 28, 2006, discloses a face identification method under the assumption of the unchanged facial posture. This method is to determine the face posture class of the input image according to the training data and acquire its character after the face position in the image is obtained. The identification process partially adopts the artificial neural network. When a certain output unit becomes active, the human face corresponding to this unit pertains to this member. If no output unit becomes active, it represents that this input image does not pertain to the member in the database. However, the technology disclosed in the '697 patent directly adopts the architecture of the single artificial neural network, and its network structure is very complicated. When the data of a new member have to be expanded, the overall artificial neural network has to be re-trained in a complicated and slow manner.

Furthermore, U.S. Pat. No. 7,295,687 (hereinafter referred to as the '687 patent), issued on Nov. 13, 2007, discloses a face identification method adopting the artificial intelligence artificial neural network. This method is to adopt an eigenpaxel selection unit to generate the facial character, and adopt an eigenfiltering unit to perform a front process on the input image, and the number of neurons of the artificial neural network can be determined according to the number of the eigenpaxels. When the input image enters this system, different values are obtained at the output end of the artificial neural network, and then the eigenpaxel corresponding to the maximum value is selected as the basis for the determination of the identification result. However, the method of the '687 patent incorrectly judges the testers as a certain member in the database when the tester is not a member in the database.

### SUMMARY

The disclosure is directed to a face identification method for identifying database character vectors in to-be-identified data and a database using multiple back propagation neural networks (BPNNs). Thus, compared with the conventional face identification method, the face identification method of the disclosure has the advantage of enhancing the face identification ability of identifying the face characters in the real-time and flexible manner.

According to a first aspect of the present disclosure, a face identification method for identifying to-be-identified data, which include an input character vector, is provided. The face identification method includes the following steps. First, a first set of hidden layer parameters and a second set of hidden layer parameters are respectively obtained by way of training according to a plurality of first training character data and a plurality of second training character data, which correspond to a first database character vector and a second database character vector, respectively. Next, a first back propagation neural network (BPNN) and a second BPNN are established according to the first and second sets of hidden layer parameters, respectively. Then, the to-be-identified data are provided to the first BPNN to find a first output character vector. Next, whether the first output character vector satisfies an identification criterion is determined. Then, the to-be-identified data are provided to the second BPNN to find a second output character vector when the first output character vector does not satisfy the identification criterion. Next, whether the second output character vector satisfies the identification criterion is determined. The to-be-identified data are identified as corresponding to the second database character vector when the second output character vector satisfies the identification criterion.

According to a second aspect of the present disclosure, a face identification system for identifying to-be-identified data, which include an input character vector, is provided. The face identification system includes a face detection circuit, a character analyzing circuit and an identification circuit. The face detection circuit selects first face detection data from a first set of training image data and selects second face detection data from a second set of training image data. The character analyzing circuit performs a dimensional simplification operation on the first face detection data and the second face detection data to obtain a plurality of first training character data and a plurality of second training character data according to the first and second face detection data, respectively. The identification circuit includes a training module, a simulating module and a control module. The training module obtains a first set of hidden layer parameters and a second set of hidden layer parameters, respectively corresponding to a first database character vector and a second database character vector, by way of training according to the first training character data and the second training character data. The simulating module establishes a first back propagation neural network (BPNN) and a second BPNN according to the first and second sets of hidden layer parameters, respectively, and inputs the to-be-identified data into the first BPNN to find a first output character vector. The control module determines whether the first output character vector satisfies an identification criterion. When the first output character vector does not satisfy the identification criterion, the control module controls the simulating module to provide the to-be-identified data to the second BPNN to find a second output character vector. The control module further determines whether the second output character vector satisfies the identification criterion, and when the second output character vector satisfies the identification criterion, the control module identifies the to-be-identified data as corresponding to the second database character vector.

The above and other aspects of the disclosure will become better understood with regard to the following detailed description of the non-limiting embodiment(s). The following description is made with reference to the accompanying drawings.

### BRIEF DESCRIPTION OF THE DRAWINGS

FIG. 1 is a block diagram showing a face identification system according to an embodiment of the disclosure.

FIG. 2 is a detailed block diagram showing an identification circuit 14 of FIG. 1.

FIGS. 3 and 4 are schematic illustrations showing the first and second BPNNs.

FIG. 5A is a schematic illustration showing a database established by a simulating module 14b in a training stage operation according to the embodiment of the disclosure.

FIG. 5B is another schematic illustration showing a database established by the simulating module 14b in the training stage operation according to the embodiment of the disclosure.

FIG. 6 is a flow chart showing a face identification method according to the embodiment of the disclosure.

FIG. 7 is a partial flow chart showing the face identification method according to the embodiment of the disclosure.

FIG. 8 is a partial flow chart showing the face identification method according to the embodiment of the disclosure.

### DETAILED DESCRIPTION

In the following detailed description, for purpose of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

The face identification method according to the embodiment of the disclosure adopts multiple BPNNs to perform the face identification operation.

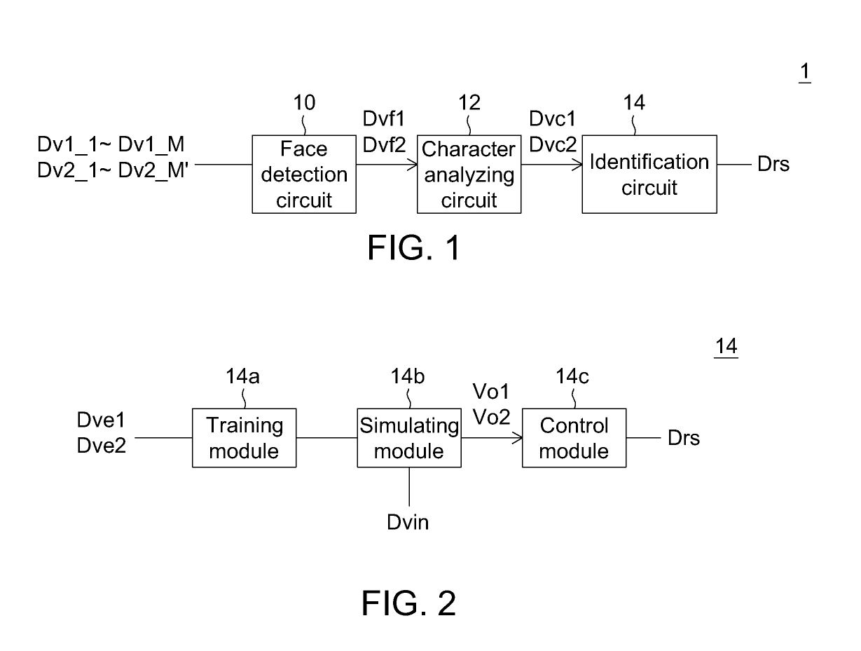

FIG. 1 is a block diagram showing a face identification system 1 according to an embodiment of the disclosure. Referring to FIG. 1, the face identification system 1 includes a face detection circuit 10, a character analyzing circuit 12 and an identification circuit 14. For example, the face identification system 1 includes a training stage operation and an identification stage operation. In the training stage operation, the face detection circuit 10, the character analyzing circuit 12 and the identification circuit 14 of the face identification system 1 establish multiple BPNNs, respectively corresponding to multiple database character vectors, in the identification circuit 14 according to the training data. Each database character vector corresponds to multiple face characters of one database member.

In the identification stage operation, the face identification system 1 performs the identification operation on the inputted to-be-identified data Dvin. For example, the to-be-identified data Dvin include an input character vector, and the identification circuit 14 of the face identification system 1 generates corresponding output character vectors according to the input character vector successively through the BPNNs, respectively, and compares the output character vectors with each of the database character vectors to perform the identification operation on the to-be-identified data.

The face identification system 1 according to this embodiment of the disclosure trains many artificial neural networks respectively corresponding to multiple database members in the database. In the following example, the training stage operation of the face identification system 1 according to the embodiment of the disclosure will be described in detail.

The face detection circuit 10 selects first face detection data Dvf1 from a first set of training image data Dv1_1, Dv1_2, . . . , Dv1_M, and selects second face detection data Dvf2 from a second set of training image data Dv2_1, Dv2_2, . . . , Dv2_M′, wherein M and M′ are natural numbers greater than 1.

In one operation example, the first set of training image data

Dv1_1-Dv1_M are the M image data (e.g., different M personal photos) of the first database member, and the face detection circuit 10 selects a face image region from each of the training image data of the first set of training image data Dv1_1-Dv1_M to obtain face detection data Dvf1. For example, the face detection circuit 10 finds the image region corresponding to the face from the first set of training image data Dv1_1-Dv1_M by way of face skin color segmentation according to the color information of the face skin color. The face detection circuit 10 further adopts the morphology approximation operation to repair the hole portions and the discontinuous portions of the face image region and thus to find the first face detection data Dvf1. In one example, the face detection circuit 10 further adopts the projection aspect ratio mechanism to screen the regions, which may not pertain to the face, from the face image region. In another example, the face detection circuit 10 further adopts the attentional cascade technology to determine whether the face image region corresponds to the front side of the human face, and thus to screen the face detection data Dvf1 of the front side of the human face.

Similar to the operation of the face detection circuit 10 for finding the face detection data Dvf1, the face detection circuit 10 further performs the similar operation to find the face detection data Dvf2 according to the second set of training image data Dv2_1-Dv2_M′.

The character analyzing circuit 12 performs a dimensional simplifying operation on the first and second face detection data Dvf1 and Dvf2 to obtain multiple first training character data Dvc1 according to the first face detection data Dvf1 and to obtain multiple second training character data Dvc2 according to the second face detection data Dvf2. For example, the character analyzing circuit 12 adopts the Karhunen-Loeve transformation technology in the image identification and image compression technology field to project the first and second face detection data Dvf1 and Dvf2 onto a smaller dimensional sub-space formed by the known vector template, so that the technological effect of simplifying the data quantities of the first and second face detection data Dvf1 and Dvf2 can be achieved.

FIG. 2 is a detailed block diagram showing the identification circuit 14 of FIG. 1. Referring to FIG. 2, the identification circuit 14 includes a training module 14a, a simulating module 14b and a control module 14c. The training module 14a obtains a first set of hidden layer parameters by way of training according to the first training character data Dvc1, and obtains a second set of hidden layer parameters by way of training according to the second training character data Dvc2. The simulating module 14b establishes a first BPNN N1 and a second BPNN N2 according to the first and second sets of hidden layer parameters, respectively.

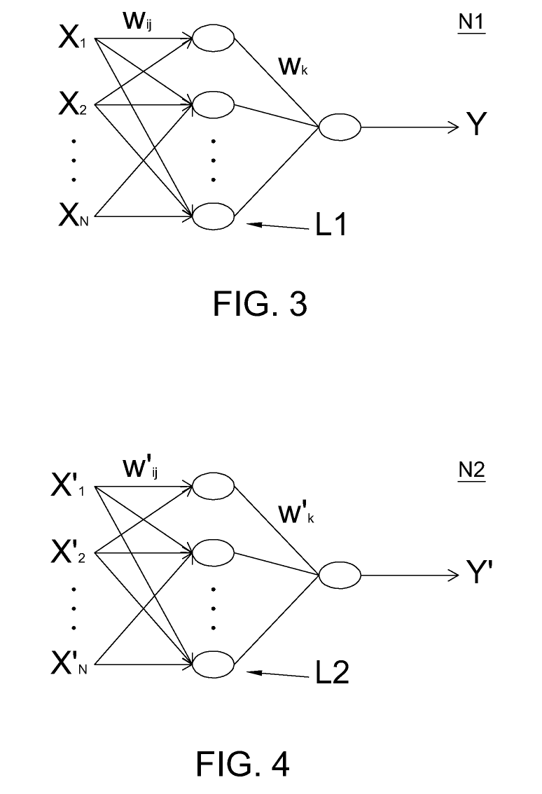

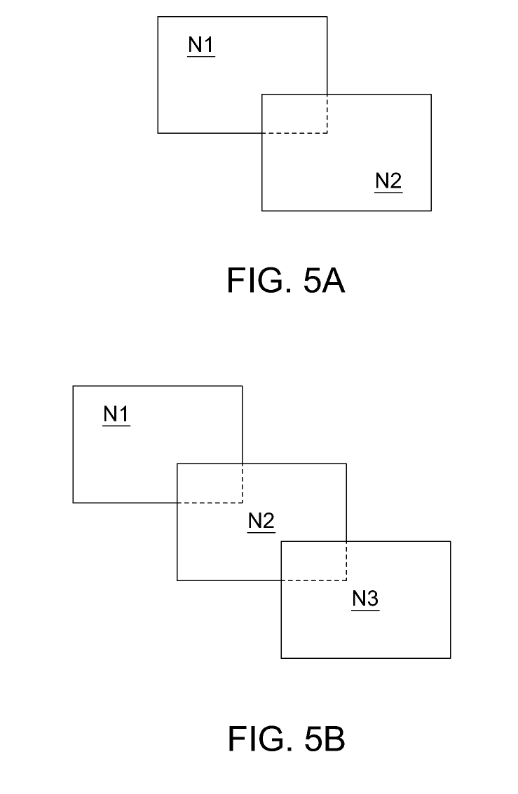

For example, FIGS. 3 and 4 are schematic illustrations showing the first and second BPNNs. For the first BPNN N1, X1 to XN represent N components of each of the training character data in the training character data Dvc1 ; Wij and Wk represent the first set of hidden layer parameters, wherein Wij determines the weighting coefficient parameter between each of the components X1 to XN and the first hidden layer L1, Wk determines the weighting coefficient parameter of the element in the first hidden layer L1, and Y represents the first database output character vector. Similarly, each of the parameters X′1-X′N, W′ij, W′k and Y′ in the second BPNN N2 also has the similar definition, so detailed descriptions thereof will be omitted. The training stage operation is completed when the first BPNN N1 capable of corresponding each of the first training character data Dvc1 to the first database character vector Y and the second BPNN N2 capable of corresponding each of the second training character data Dvc2 to the second database character vector Y′ have been completely established. In one example, the simulating module 14b finishes the operation of establishing the database including two BPNNs (i.e., the first BPNN N1 and the second BPNN N2 respectively corresponding to the first and second database members) after the training stage operation ends, wherein the schematic illustration of this database is shown in FIG. 5A.

When the face identification system 1 according to the embodiment of the disclosure enters the identification stage, the inputted face character data are successively transmitted to the artificial neural networks corresponding to each of the database members, wherein each of the artificial neural networks correspondingly obtains an output value. For example, the inputted face character data are firstly inputted to the first artificial neural network corresponding to the first database member. Then, the face identification system 1 according to the embodiment of the disclosure determines whether the inputted face data correspond to the first database member in the artificial neural network database according to the set threshold value. If not, the face identification system 1 of the disclosure transmits the inputted face character data to the second artificial neural network corresponding to the second database member, and determines whether the inputted face data correspond to the second database member. Similar steps may be analogized and performed to successively determine whether the inputted face character data correspond to each database member in the database. If the inputted face character data are determined as not corresponding to any database member, then it is determined that the inputted face character data do not pertain to the database member. In the following example, the identification stage operation of the face identification system 1 according to the embodiment of the disclosure will be described in detail.

In the identification stage operation, the simulating module 14b firstly inputs the to-be-identified data Dvin to the first BPNN N1 to obtain the corresponding first output character vector Vo1. The control module 14c determines whether the first output character vector Vo1 satisfies the identification criterion. For example, the identification criterion is that the distance between the first output character vector Vo1 and the first database character vector is smaller than a threshold value. Thus, the control module 14c determines whether the to-be-identified data Dvin correspond to the image frame of the first database member by determining whether the first output character vector Vo1 corresponds to the first database character vector. When the first output character vector Vo1 does not satisfy the identification criterion, it represents that the to-be-identified data Dvin do not approximate the first database character vector. That is, the image contents displayed according to the to-be-identified data Dvin do not correspond to the face character of the first database member.

When it is determined that the to-be-identified data Dvin do not correspond to the image frame of the first database member, the control module 14c controls the simulating module 14b to provide the to-be-identified data Dvin to the second BPNN to correspondingly find the second output character vector Vo2. The control module 14c further determines whether the second output character vector Vo2 satisfies the identification criterion. When the second output character vector Vo2 satisfies the identification criterion, it represents that the to-be-identified data Dvin approximates the second database character vector. That is, the image contents displayed according to the to-be-identified data Dvin corresponds to the face character of the second database member. Thus, the control module 14c outputs identification result data Drs, which indicate that the to-be-identified data Dvin are identified as corresponding to the face image of the second database member.

In this illustrated embodiment, although the face identification system 1 establishes the BPNNs N1 and N2 corresponding to the two database character vectors, and thus determines whether the to-be-identified data Dvin correspond to the face identification operation of any one of the two database members, the face identification system 1 of this embodiment is not limited thereto, and may further establish three or more than three BPNNs, and thus determine whether the to-be-identified data Dvin correspond to any one of three or more than three database members. For example, the face identification system 1 establishes three BPNNs N1, N2 and N3 in the training stage operation, wherein the schematic illustration of the database including the three BPNNs N1, N2 and N3 is shown in FIG. 5B. Therefore, when the second output character vector Vo2 does not satisfy the identification criterion, the control module 14c further controls the simulating module 14b to provide the to-be-identified data Dvin to the third BPNN to correspondingly find the third output character vector; and the control module 14c further determines whether the third output character vector satisfies the identification criterion to determine whether the to-be-identified data Dvin correspond to the face image of the third database member.

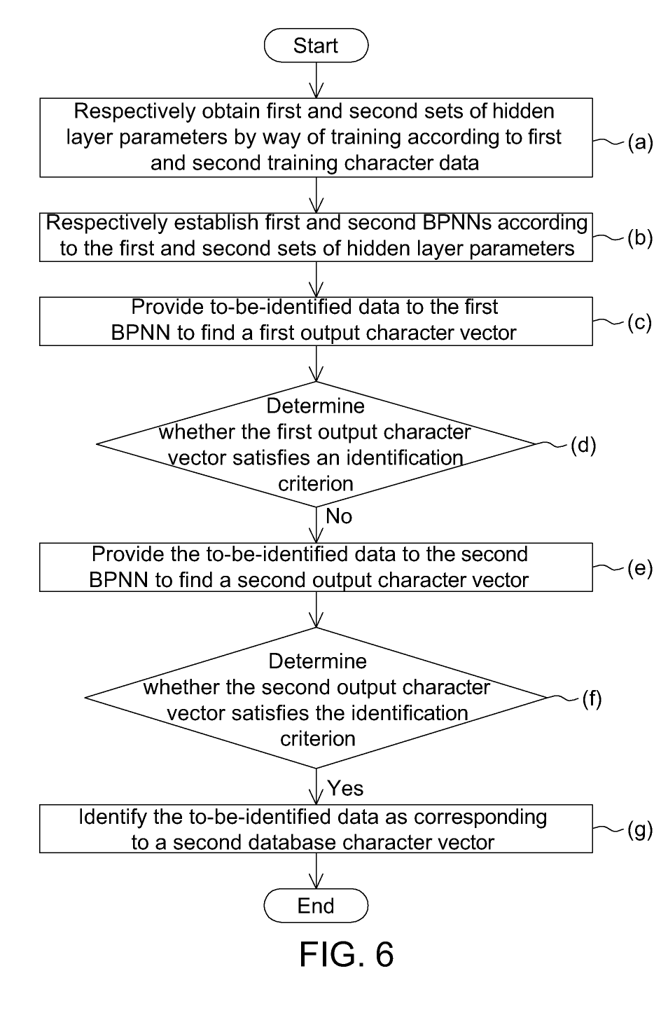

FIG. 6 is a flow chart showing a face identification method according to the embodiment of the disclosure. Referring to FIG. 6, the face identification method for identifying the to-be-identified data Dvin according to the embodiment of the disclosure includes the following steps. First, as shown in step (a), the simulating module 14b obtains a first set of hidden layer parameters by way of training according to first training character data Dv1_1 to Dv1_M, and obtains a second set of hidden layer parameters by way of training according to second training character data Dv2_1 to Dv2_M′, wherein the first and second sets of hidden layer parameters respectively correspond to the first database character vector and the second database character vector. Next, as shown in step (b), the simulating module 14b establishes the first BPNN and the second BPNN according to the first and second sets of hidden layer parameters, respectively.

Then, as shown in step (c), the simulating module 14b provides the to-be-identified data Dvin to the first BPNN to find the first output character vector Vo1. Next, as shown in step (d), the control module 14c determines whether the first output character vector Vo1 satisfies the identification criterion. If not, step (e) is performed, in which the simulating module 14b provides the to-be-identified data Dvin to the second BPNN to find the second output character vector Vo2. Then, step (f) is performed, in which the control module 14c determines whether the second output character vector Vo2 satisfies the identification criterion. If so, step (g) is performed, in which the control module 14c outputs the identification result data Drs, which indicate that the to-be-identified data Din are identified as corresponding to the image data of the second database character vector (i.e., the face character of the second database member).

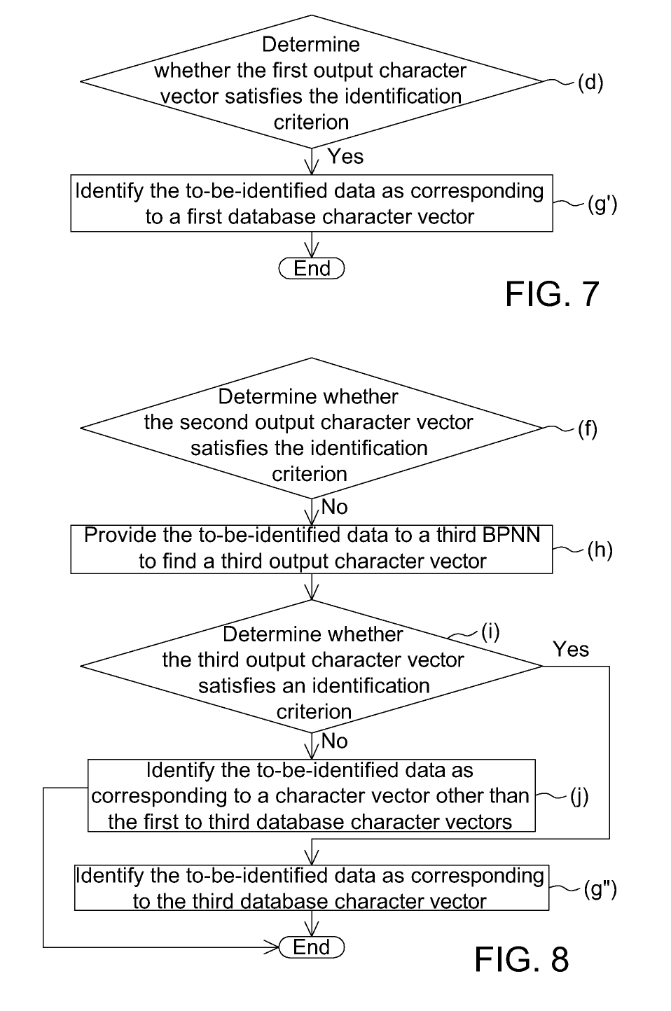

FIG. 7 is a partial flow chart showing the face identification method according to the embodiment of the disclosure. After the step (d), when the first output character vector Vo1 satisfies the identification criterion, step (g′) is performed, in which the control module 14c outputs the identification result data Drs, which indicate that the to-be-identified data Din are identified as corresponding to the image data of the first database character vector (i.e., the face character of the first database member).

FIG. 8 is a partial flow chart showing the face identification method according to the embodiment of the disclosure. In one example, the simulating module 14b further obtains a third set of hidden layer parameters by way of training according to multiple third training character data, and establishes the third BPNN according to the third set of hidden layer parameters in the steps (a) and (b). After the step (f), when the second output character vector Vo2 does not satisfy the identification criterion, step (h) is performed, in which the simulating module 14b provides the to-be-identified data Dvin to the third BPNN to find the third output character vector. Next, as shown in step (i), the control module 14c determines whether the third output character vector satisfies the identification criterion. If yes, step (g″) is performed, in which the control module 14c outputs the identification result data Drs, which indicate that the to-be-identified data Din are identified as corresponding to the image data of the third database character vector (i.e., the face character of the third database member). If not, step (j) is performed, in which the control module 14c outputs the identification result data Drs, which indicate that the to-be-identified data Din are not identified as any one of the first to third database character vectors, and as not corresponding to a face character of any one of the first to third database members.

The disclosure firstly establishes the BPNNs representing the members according to the face training character data of the members, respectively. When the to-be-identified face data enter the identification system, the to-be-identified face character data are successively provided to the BPNN of each member to find the individual output character vector. Then, it is determined whether the output character vector satisfies the identification criterion. If yes, the to-be-identified data are identified as corresponding to the member. If not, the to-be-identified data are provided to the BPNN of the next member to find the next output character vector. After the to-be-identified data are provided to the BPNN of the member in the database and all the output character vectors thereof do not satisfy the identification criterion, the to-be-identified data are identified as not pertaining to the database member.

According to the other aspect of the disclosure, a face identification system for identifying the to-be-identified data, which include the input character vector, is provided. The face identification system includes a face detection circuit, a character analyzing circuit and an identification circuit. The face detection circuit respectively selects individual face detection data from each set of training image data. The character analyzing circuit performs the dimensional simplification operation on the individual face detection data, and respectively obtains the training character data of each member according to the face detection data. The identification circuit includes a training module, a simulating module and a control module. The training module respectively obtains the hidden layer parameter of each member, corresponding to the database character vector of each member, by way of training according to the training character data of each member. The simulating module establishes the BPNN of each member according to the hidden layer parameter of each member. The simulating module further inputs the to-be-identified data to the BPNN of each member to find the output character vector of each member. The control module determines whether the output character vector of each member satisfies the identification criterion. If not, the simulating module transfers the to-be-identified data to the BPNN of another member to find the corresponding output character vector. The control module further determines whether the corresponding output character vector satisfies the identification criterion. If yes, the control module identifies the to-be-identified data as corresponding to the database member.

The face identification method according to the embodiment of the disclosure adopts the multiple BPNNs to identify the multiple database character vectors in the to-be-identified data and the database. Consequently, when the database character vectors in the database have to be increased or decreased, the new BPNN can be trained by simply providing the new training data, or the current BPNN obtained in the training can be deleted. Thus, compared with the conventional face identification method, the face identification method according to the embodiment of the disclosure advantageously has the higher flexibility of changing the database character vectors.

In addition, the face identification method according to the embodiment of the disclosure further adopts the Karhunen-Loeve dimensional transformation technology to reduce the dimension of the character vector. Thus, compared with the conventional face identification method, the face identification method according to the embodiment of the disclosure further advantageously has the real-time face identification ability.

In one embodiment, the face identification method according to the embodiment of the disclosure is applied to the actual application occasion of the family member identification for the robot so that the robot can identify whether the database member is the known family member, and thus independently determine the suitable interaction response. Thus, the robot adopting the face identification method according to the embodiment of the disclosure can identify the to-be-identified face as corresponding to the member other than the family members, and can further respond with different interactions to different family members so that the functions of taking care of the family members or visitors can be achieved.

In an example, the face identification method disclosed in the disclosures can be implemented as program codes stored in any kind of computer readable mediums, such as CD-ROMs, hard drives, flash memory, and so on and circuit units within the face identification system 1, e.g. the face detection circuit 10, the character analyzing circuit 12 and the identification circuit 14, can be implemented as computer systems, which are capable of accessing the computer readable mediums and realizing the face identification method accordingly.

In other example, the circuit units within the face identification system 1 may also be implemented as present logic circuits, such as application specific integrated circuit (ASIC), field programmable gate array (FPGA), complex programmable logic device (CPLD), and so on, programmed with the capabilities of executing the face identification method disclosed in the disclosures.

The face identification method according to the embodiment of the disclosure respectively establishes multiple corresponding artificial neural networks with respect to all the family members in the face identification database. Compared with the prior art, which establishes one single complicated network according to multiple sets of face identification data, the face identification method of the disclosure can enhance the identification rate, and can further make the training and learning of the face identification system become more efficient when the to-be-identified family members are to be increased or decreased flexibly.

While the disclosure has been described by way of example and in terms of the exemplary embodiment(s), it is to be understood that the disclosure is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A face identification method for identifying to-be-identified data, which comprise an input character vector, the face identification method comprising the steps of:
respectively obtaining a first set of hidden layer parameters and a second set of hidden layer parameters by way of training according to a plurality of first training character data and a plurality of second training character data, which correspond to a first database character vector and a second database character vector, respectively;
establishing a first back propagation neural network (BPNN) and a second BPNN according to the first and second sets of hidden layer parameters, respectively;
providing the to-be-identified data to the first BPNN to find a first output character vector;
determining whether the first output character vector satisfies an identification criterion;
providing the to-be-identified data to the second BPNN to find a second output character vector when the first output character vector does not satisfy the identification criterion;
determining whether the second output character vector satisfies the identification criterion; and
identifying the to-be-identified data as corresponding to the second database character vector when the second output character vector satisfies the identification criterion.

2. The method according to claim 1, further comprising, after the step of determining whether the first output character vector satisfies the identification criterion, the step of:
identifying the to-be-identified data as corresponding to the first database character vector when the first output character vector satisfies the identification criterion.

3. The method according to claim 1, wherein the steps of obtaining the first and second sets of hidden layer parameters and establishing the first and second BPNNs respectively comprise:
obtaining a third set of hidden layer parameters corresponding to a third database character vector by way of training according to a plurality of third training character data; and
establishing a third BPNN according to the third set of hidden layer parameters.

4. The method according to claim 3, further comprising, after the step of determining whether the second output character vector satisfies the identification criterion, the steps of:
providing the to-be-identified data to the third BPNN to find a third output character vector when the second output character vector does not satisfy the identification criterion;
determining whether the third output character vector satisfies the identification criterion; and
identifying the to-be-identified data as corresponding to the third database character vector when the third output character vector satisfies the identification criterion.

5. The method according to claim 4, further comprising, after the step of determining whether the third output character vector satisfies the identification criterion, the step of:
identifying the to-be-identified data as corresponding to a character vector other than the first to third database character vectors when the third output character vector does not satisfy the identification criterion.

6. The method according to claim 1, further comprising the steps of:
selecting first face detection data from a first set of training image data and selecting second face detection data from a second set of training image data according to face skin color segmentation, morphology hole filling and attentional cascade; and
performing a dimensional simplification operation on the first face detection data and the second face detection data to obtain the first training character data and the second training character data according to the first and second face detection data, respectively.

7. The method according to claim 6, wherein the dimensional simplification operation is performed on the first and second sets of training character data by way of Karhunen-Loeve transformation.

8. A face identification system for identifying to-be-identified data, which comprise an input character vector, the face identification system comprising:
a face detection circuit for selecting first face detection data from a first set of training image data and selecting second face detection data from a second set of training image data;
a character analyzing circuit for performing a dimensional simplification operation on the first face detection data and the second face detection data to obtain a plurality of first training character data and a plurality of second training character data according to the first and second face detection data, respectively; and
an identification circuit, comprising:
a training module for obtaining a first set of hidden layer parameters and a second set of hidden layer parameters, respectively corresponding to a first database character vector and a second database character vector, by way of training according to the first training character data and the second training character data;
a simulating module for establishing a first back propagation neural network (BPNN) and a second BPNN according to the first and second sets of hidden layer parameters, respectively, and for inputting the to-be-identified data into the first BPNN to find a first output character vector; and
a control module for determining whether the first output character vector satisfies an identification criterion, wherein when the first output character vector does not satisfy the identification criterion, the control module controls the simulating module to provide the to-be-identified data to the second BPNN to find a second output character vector;
wherein the control module further determines whether the second output character vector satisfies the identification criterion, and when the second output character vector satisfies the identification criterion, the control module identifies the to-be-identified data as corresponding to the second database character vector.

9. The system according to claim 8, wherein when the first output character vector satisfies the identification criterion, the control module identifies the to-be-identified data as corresponding to the first database character vector.

10. The system according to claim 8, wherein:
the training module further obtains a third set of hidden layer parameters by way of training according to a plurality of third training character data, which correspond to a third database character vector; and
the simulating module further establishes a third BPNN according to the third set of hidden layer parameters.

11. The system according to claim 10, wherein:
when the second output character vector does not satisfy the identification criterion, the control module further determines whether a third output character vector satisfies the identification criterion; and
when the third output character vector satisfies the identification criterion, the control module identifies the to-be-identified data as corresponding to the third database character vector.

12. The system according to claim 11, wherein:
when the third output character vector does not satisfy the identification criterion, the control module identifies the to-be-identified data as corresponding to a character vector other than the first to third database character vectors.

13. The system according to claim 8, wherein the face detection circuit selects the first and second face detection data by way of face skin color segmentation, morphology hole filling and attentional cascade.

14. The system according to claim 8, wherein the character analyzing circuit performs the dimensional simplification operation on the first and second face detection data by way of Karhunen-Loeve transformation.
